(19) United States
(12) Patent Application Publication
(10) Pub. No.: US 2005/0088564 A1
(43) Pub. Date: Apr. 28, 2005

(54) Image sensor module of camera apparatus and assembling method thereof

(76) Inventors: Sang-Ho Kim, Gumi-si (KR); Yeong-Seop Lee, Gumi-si (KR); Do-Hyung Lee, Dalsco-gu (KR); Hyun-Ju Lee, Chilgok-gun (KR)

Correspondence Address: CHA & REITER, LLC, 210 ROUTE 4 EAST STE 103, PARAMUS, NJ, 07652, US

(21) Appl. No.: 10/763,984

(22) Filed: Jan. 23, 2004

(30) Foreign Application Priority Data
Oct. 23, 2003 (KR) 2003-74106

(51) Int. Cl. H04N 5/225

(52) U.S. Cl. 348/340

(57) ABSTRACT

Disclosed are an image sensor module of a camera and an assembling method thereof capable of simultaneously bonding a circuit pattern and an infrared ray filter to an upper surface of a circuit board section. The image sensor module has the circuit board section including a bonding part made of transparent material. The circuit board section has an upper surface onto which the circuit pattern and the infrared ray filter are simultaneously bonded. An image sensor chip is bonded to a lower surface of the circuit board section using a flip chip bonding technique. A lens holder is bonded to the upper surface of the circuit board section using an epoxy bonding process. A lens assembly is bonded to an upper surface of the lens holder using the epoxy bonding process.

### CLAIM OF PRIORITY

This application claims priority to an application entitled “Image sensor module of camera apparatus and assembling method thereof,” filed in the Korean Intellectual Property Office on Oct. 23, 2003 and assigned Ser. No. 2003-74106, the contents of which are hereby incorporated by reference.

### BACKGROUND OF THE INVENTION

1. Field of the Invention

The present invention relates to an image sensor module of a camera apparatus and an assembling method thereof. More particularly, the invention relates to an image sensor module of a camera apparatus and an assembling method thereof, in which a circuit pattern and an infrared ray filter are simultaneously attached to a surface of a printed circuit board, when assembling the image sensor module of the camera apparatus.

2. Description of the Related Art

Image pickup devices are provided in various electronic apparatuses to recognize an image. The image pickup device is called a “camera lens module”. The camera lens module includes a camera lens. The electronic apparatuses include a video camera, an electronic still camera, a PC camera terminal, and a PDA. A conventional portable terminal includes the camera lens module to enable a user to make image communication with other users or photograph an object. That is, in addition to voice and character transmission functions, potable communication devices are equipped with a camera for photographing, storing and transmitting an image.

Although quality images in mega-pixel units can be achieved by using the camera lens module, there are problems in fabricating the camera lens module.

First, it is difficult to manage particles that become attached to an image sensor and an infrared ray filter lens. Particularly, when fabricating the camera lens module through a conventional method, particles are inevitably attached to an upper surface of the infrared filter.

The image sensor includes a CMOS image sensor. The CMOS image sensor is a switch-type device capable of sequentially detecting outputs using MOS transistors. They are fabricated corresponding to a number of pixels by using a CMOS technique where a control circuit and a signal processing circuit are used as a peripheral circuit. Advantageously, the CMOS image sensor has low power consumption. Thus, they are particularly useful in portable mobile devices, such as cellular phones.

Hereinafter, a conventional assembling process for an image sensor used in a conventional digital optical instrument will be described.

As shown in FIG. 1, according to a chip on board (COB) process, an image sensor chip 12 is attached to an upper surface of a printed circuit board 10 including a flexible printed circuit board 11 through a die bonding technique. Then, a wire bonding process is carried out in order to electrically connect a circuit pattern pad of the printed circuit board 10 to an image sensor pad of the image sensor by using a wire 13. In this state, a lens holder 15 having an infrared ray filter 14 therein is bonded to the upper surface of the printed circuit board 10 and a lens assembly 16 is bonded to the lens holder 15.

As shown in FIG. 2, according to a chip of film (COF) process, a flexible printed circuit board 20 is fabricated by using an anisotropic conductive film (ACF) 21, which is electrically connected to the flexible printed circuit board 20. A circuit pattern formed with a bonding pad and a ball pad is fixedly pre-bonded to an upper surface of the flexible printed circuit board 20 by means of the anisotropic conductive film 21. An image sensor 23 is provided above the flexible printed circuit board 20 through a flip chip bonding process. The image sensor 23 has conductivity by means of anisotropic conductive film balls. A lens holder 24 having an infrared ray filter 23 therein is bonded to an upper portion of the flexible printed circuit board 20 through an epoxy bonding process. A lens assembly 25 is bonded to an upper portion of the lens holder 24.

According to a CSP process as shown in FIG. 3, an image sensor chip 32 is bonded to an upper surface of a printed circuit board 30 having a flexible circuit board 31 through a die bonding technique. After coating transparent material on an upper surface of the image sensor chip 32, the upper surface of the image sensor chip 32 is covered with glass 33. In this state, glass 33 is conductively coupled to an upper pad. Then, a sawing process is carried out so as to produce the image sensor chip 32. After the image sensor chip 32 has been produced, the image sensor chip 32 is bonded to the upper surface of the printed circuit board 30 by using attaching equipment. The image sensor chip 32 is subject to a heat treatment process by passing the image sensor chip 32 through an oven. Thus, a solder ball is molten so that the image sensor chip 32 is conductively coupled to the printed circuit board 30. Then, a lens holder 35 having an infrared ray filter 34 therein is nodded to the upper surface of the printed circuit board 30, and a lens assembly 36 is bonded to the lens holder 35.

However, according to the COB and COF processes, surfaces of the printed circuit board and the flexible printed circuit board are exposed to an atmosphere for an extended period of time. During this period particles are attached to a surface of a lens, thereby increasing a fault rate.

In addition, the COB, COF, and CSP processes have limitations in fabricating a slimmer image sensor modules with a compact size, because fixing work for the parts is difficult in the above processes. In addition, the assembling process is very complicated for the image sensor module, since it requires various steps. Furthermore, since various parts are required, the fabricating cost is increased.

### SUMMARY OF THE INVENTION

Accordingly, the present invention has been made to reduce or overcome the above-mentioned problems occurring in the prior art. One object of the present invention is to provide an image sensor module of a camera apparatus and an assembling method thereof, in which a circuit pattern and an infrared ray filter are simultaneously attached to a surface of a circuit board section, when assembling the image sensor module of the camera apparatus. Thus, the exposure time of the printed circuit board to the exterior is reduced, thereby decreasing particles and lowering a fault rate of the camera apparatus. In turn, this improves the image quality of a lens.

Another object of the present invention is to provide an image sensor module of a camera apparatus and an assembling method thereof, in which a bonding section formed in a circuit board section for bonding a circuit pattern and an infrared ray filter to the circuit board section is made of transparent material. This enables an easier assembling process of the image sensor module and reduces parts required for the assembling process. Thus, manufacturing cost of the image sensor module is reduced.

In accordance with the principles of the present invention, an image sensor module of a camera apparatus is provided, wherein the image sensor module comprises a circuit board section including transparent material and having an upper surface onto which a circuit pattern and an infrared ray filter are simultaneously bonded; an image sensor chip bonded to a lower surface of the circuit board section using a flip chip bonding technique; a lens holder bonded to the upper surface of the circuit board section using an epoxy bonding process; and a lens assembly bonded to an upper surface of the lens holder using the epoxy bonding process.

According to another aspect of the present invention, there is provided a method for assembling an image sensor module of a camera apparatus, the method comprising the steps of: simultaneously bonding a circuit pattern and an infrared ray filter to an upper surface of a circuit board section; bonding an image sensor chip to a lower surface of the circuit board section through a flip chip bonding technique; bonding a lens holder to the upper surface of the circuit board section through an epoxy bonding process; and bonding a lens assembly to an upper surface of the lens holder through the epoxy bonding process.

### BRIEF DESCRIPTION OF THE DRAWINGS

The present invention will be more apparent from the following detailed description taken in conjunction with the accompanying drawings, in which:

FIG. 1 is a side sectional view showing a method for fabricating a conventional image sensor module through a COB process;

FIG. 2 is a side sectional view showing a method for fabricating a conventional image sensor module through a COF process;

FIG. 3 is a side sectional view showing a method for fabricating a conventional image sensor module through a CSP process;

FIG. 4 is a side sectional view showing a circuit pattern and an infrared ray filter of an image sensor module of a camera apparatus according to one embodiment of the present invention;

FIG. 5 is a sectional view showing an image sensor module of a camera apparatus according to one embodiment of the present invention; and

FIG. 6 is a flow chart showing a method for assembling an image sensor module of a camera apparatus according to one embodiment of the present invention.

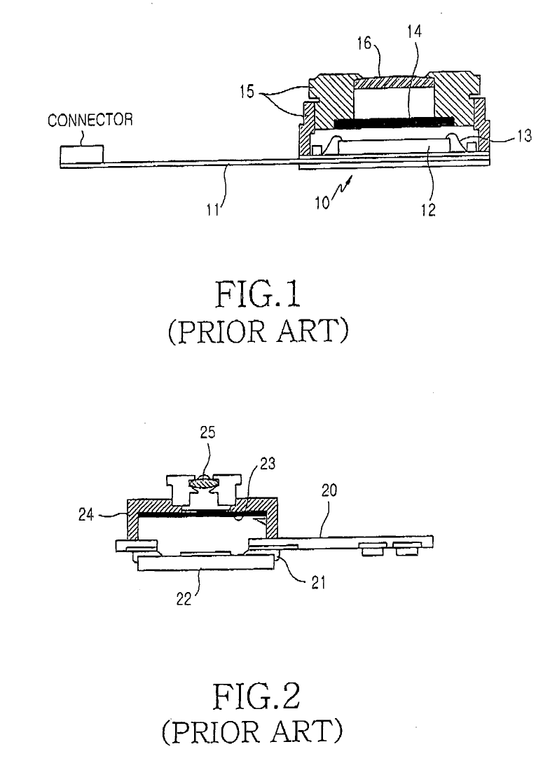

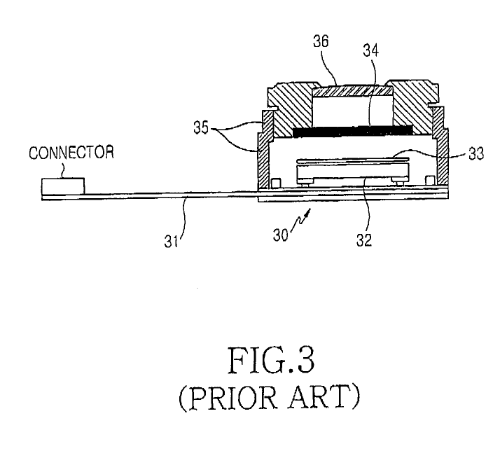

### DETAILED DESCRIPTION OF THE PREFERRED EMBODIMENT

Hereinafter, a preferred embodiment of the present invention will be described with reference to the accompanying drawings. In the following description of the present invention, the same reference numerals are used to designate the same or similar components and a detailed description of known functions and configurations incorporated herein will be omitted when it may make the subject matter of the present invention rather unclear.

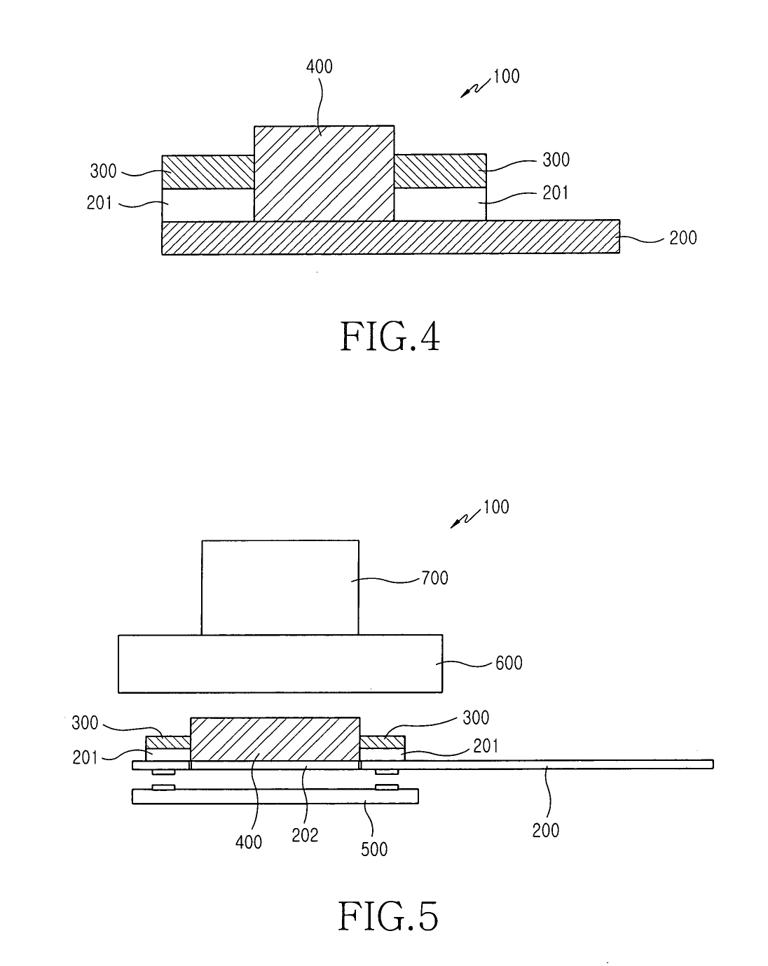

As shown in FIGS. 4 and 5, an image sensor module of a camera apparatus according to one embodiment of the present invention includes a circuit board section 200, an image sensor chip 500, a lens holder 600 and a lens assembly 700. A bonding section 201 is coated on an upper surface of the printed circuit board 200. A circuit pattern 300 and an infrared ray filter 400 are simultaneously bonded to an upper surface of the bonding section 201. The image sensor chip 500 is bonded to a lower portion of the printed circuit board 200 through a flip chip bonding technique. The lens holder 600 is bonded to the upper surface of the circuit board section 200 through an epoxy bonding process in such a manner that the lens assembly 700 is accommodated in the lens holder 600. The lens assembly 700 has a camera lens and is bonded to the lens holder 600 through the epoxy bonding process. The bonding section 201 formed on the printed circuit board 200 for bonding the circuit pattern 300 and the infrared ray filter 400 is made of transparent material. Transparent material includes CU PET or CU PI. In addition, the circuit board section 200 includes a printed circuit board or a flexible printed circuit board.

Hereinafter, the operation of the image sensor module of the camera apparatus of the present invention will be described with reference to FIGS. 4 and 5.

As shown in FIG. 4, after the bonding section 201 is coated on the upper surface of the circuit board section 200, the circuit pattern 300 and the infrared ray filter 400 are simultaneously bonded to an upper surface of the bonding section 201. Bonding work for the circuit pattern 300 and the infrared ray filter 400 can be easily performed, since the bonding section 201 formed on the circuit board section 200 to bond the circuit pattern 300 and the infrared ray filter 400 is made of transparent maternal.

Since the upper portion of the circuit board section 200 is exposed to the exterior, if impurities are generated, the image sensor module may fail. Thus, it is necessary to rapidly cover the upper surface of the circuit board section 200. To this end, the circuit pattern 300 and the infrared ray filter 400 are simultaneously bonded to the upper surface of the circuit board section 200, thereby preventing impurities from penetrating into the circuit board section 200.

As shown in FIG. 5, the image sensor chip 500 is bonded to a lower surface of the circuit board section 200 through the flip chip bonding technique. Then, the lens holder 600 is bonded to the upper surface of the circuit board section 200 through the epoxy bonding process. The lens assembly 700 is bonded to the upper surface of the lens holder 600 through the epoxy bonding process. The circuit board section 200 is made of CU PET or CU PI. In addition, the circuit board section 200 includes the printed circuit board or the flexible printed circuit board.

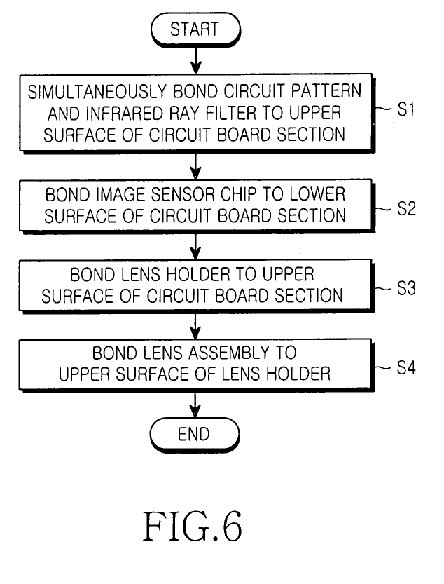

With reference to FIG. 6, a method for assembling the image sensor module of the camera apparatus of the present invention will be described. The circuit pattern 300 and the infrared ray filter 400 are simultaneously bonded to the upper surface of the circuit board section 200 (SI). Bonding work for the circuit pattern 300 and the infrared ray filter 400 is easily performed, since the bonding section 201 formed on the circuit board section 200 to bond the circuit pattern 300 and the infrared ray filter 400 is made of transparent maternal. The image sensor chip 500 is bonded to the lower surface of the circuit board section 200 through the flip chip bonding technique (S2). In addition, the lens holder 600 is bonded to the upper surface of the circuit board section 200 through the epoxy bonding process (S3). Then, the lens assembly 700 is bonded to the upper surface of the lens holder 600 through the epoxy bonding process (S4).

While the present invention has been shown and described with reference to certain preferred embodiments thereof, it will be understood by those skilled in the art that various changes in form and details may be made therein without departing from the spirit and scope of the invention as defined by the appended claims.

1. An image sensor module for use with a camera apparatus, the image sensor module comprising:
a circuit board section including a transparent material and having an upper surface onto which a circuit pattern and an infrared ray filter are simultaneously bonded;
an image sensor chip bonded to a lower surface of the circuit board section using a flip chip bonding technique;
a lens holder bonded to the upper surface of the circuit board section using an epoxy bonding process; and
a lens assembly bonded to an upper surface of the lens holder using the epoxy bonding process.

2. The image sensor module as claimed in claim 1, wherein the circuit board section includes a printed circuit board and a flexible circuit board.

3. The image sensor module as claimed in claim 1, wherein transparent material includes CU PET or CU PI.

4. A terminal comprising:
a camera lens module having an image sensor module, the image sensor including,
a circuit board section including transparent material and having an upper surface onto which a circuit pattern and an infrared ray filter are simultaneously bonded;
an image sensor chip bonded to a lower surface of the circuit board section through a flip chip bonding technique;
a lens holder bonded to the upper surface of the circuit board section through an epoxy bonding process; and
a lens assembly bonded to an upper surface of the lens holder through the epoxy bonding process.

5. The terminal as claimed in claim 4, wherein the terminal is a video camera, an electronic still camera, a PC camera terminal, or a PDA.

6. A method for assembling an image sensor module of a camera apparatus, the method comprising the steps of:
i) simultaneously bonding a circuit pattern and an infrared ray filter to an upper surface of a circuit board section;
ii) bonding an image sensor chip to a lower surface of the circuit board section using a flip chip bonding technique;
iii) bonding a lens holder to the upper surface of the circuit board section using an epoxy bonding process; and
iv) bonding a lens assembly to an upper surface of the lens holder using the epoxy bonding process.

7. The method as claimed in claim 6, wherein, in step i), a bonding part including transparent material is formed on the circuit board section in order to bond the circuit pattern and the infrared ray filter to the circuit section.
